(19) United States
(12) Patent Application Publication
(10) Pub. No.: US 2026/0254167 A1
(43) Pub. Date: Aug. 27, 2026

(54) ELECTRICAL CONNECTOR FOR FLAT CONDUCTOR

(71) Applicant: HIROSE ELECTRIC CO., LTD., Kanagawa (JP)

(72) Inventors: Kazuki AIHARA, Kanagawa (JP); Shoichiro TAMAKI, Kanagawa (JP)

(21) Appl. No.: 19/540,040

(22) Filed: Feb. 13, 2026

(30) Foreign Application Priority Data
Feb. 27, 2025 (JP) 2025-029851

(51) Int. Cl. H01R 13/639; H01R 12/88; H01R 13/506; H01R 13/627

(52) U.S. Cl. CPC H01R 13/639; H01R 12/88; H01R 13/506; H01R 13/6272

(57) ABSTRACT

Provided is an electrical connector for a flat conductor, including: a terminal; a housing; a slider; and a movable member, the movable member is rotatable between an open position and a closed position, and has a cam portion that presses the slider forward when the movable member is between the open position and the closed position, the terminal has an intermediate portion elastically displaceable in a front-rear direction, when the movable member is at the open position, the slider is positioned at a first position, when the movable member is between the open position and the closed position, the slider moves from the first position to a second position located forward of the first position, and when the movable member is at the closed position, the slider moves from the second position to a third position located rearward of the second position and forward of the first position.

### CROSS-REFERENCE TO RELATED APPLICATION

This application claims priority from Japanese Patent Application No. 2025-029851 filed with the Japan Patent Office on February 27, 2025, the entire content of which is hereby incorporated by reference.

### BACKGROUND

### Technical Field

The present disclosure relates to an electrical connector for a flat conductor.

### Related Art

As an electrical connector for a flat conductor, a connector is known in which a flat conductor extending in a front-rear direction is inserted and connected toward a front side, for example, as in JP-A-2024-113772. The connector maintains the connection between the flat conductor and the connector by a slider attached to a housing in which a plurality of terminals are arranged and held. The slider is attached to the housing from a rear side while being movable in the front-rear direction between a retracted position that allows withdrawal of the flat conductor and an advanced position that prevents withdrawal of the flat conductor.

The connector is provided with a movable member rotatable between an open position and a closed position about an axis extending in a terminal arrangement direction, and the slider interlocks, in the front-rear direction, with rotation of the movable member. Specifically, the slider moves forward toward the advanced position when the movable member rotates from the open position to the closed position, and the slider moves rearward toward the retracted position when the movable member rotates from the closed position to the open position.

Each terminal has, on a front end side, a held portion to be held by the housing, and has, on a rear end side, a contact arm portion and a pressing arm portion extending in the front-rear direction in parallel to each other. The terminal has, between the held portion and the contact arm portion/the pressing arm portion, an intermediate portion (elastic portion) elastically displaceable in the front-rear direction, the terminal arrangement direction, and an up-down direction. The slider has, on a front end side, a pressing plate portion extending in the terminal arrangement direction. When the slider is at the advanced position, the pressing plate portion enters from the rear side between the pressing arm portion and a contact portion of the terminal and presses the flat conductor from above toward the contact portion of the terminal. When an inadvertent external force acts on the flat conductor connected to the connector, elastic displacement of the intermediate portion of the terminal causes the contact portion to follow the flat conductor, and as a result, the contact between the flat conductor and the contact portion is maintained.

### SUMMARY

An electrical connector for a flat conductor according to an embodiment of the present disclosure includes: a plurality of terminals arranged in a left-right direction; a housing that holds the plurality of terminals; a slider; and a movable member, wherein the slider is attached to the housing from a rear side to be movable in a front-rear direction, the movable member is attached to the housing to be rotatable between an open position having an orientation at a predetermined angle with respect to the front-rear direction and allowing withdrawal of a flat conductor and a closed position having an orientation along the front-rear direction and restricting withdrawal of the flat conductor, the movable member has a cam portion that rotates with rotation of the movable member, the cam portion has a pressing portion that presses the slider forward when the movable member is between the open position and the closed position, the plurality of terminals each have a held portion held by a front wall of the housing, a base arm portion, a pressing arm portion extending rearward from the base arm portion and contacting the slider, a contact arm portion extending rearward from the base arm portion and having a contact portion contacting the flat conductor, and an intermediate portion connecting the held portion and the base arm portion and elastically displaceable in the front-rear direction, when the movable member is at the open position, the slider is positioned at a first position, when the movable member is between the open position and the closed position, the slider is pressed forward by the pressing portion, and the intermediate portion urged by the pressed slider elastically displaces in a compression direction, thereby moving the slider from the first position to a second position located forward of the first position, and when the movable member is at the closed position, forward pressing of the slider by the pressing portion is released, and the slider is pushed rearward by an elastic reaction force of the intermediate portion, thereby moving the slider from the second position to a third position located rearward of the second position and forward of the first position.

### BRIEF DESCRIPTION OF THE DRAWINGS

FIG. 1 is a perspective view showing an electrical connector for a flat conductor according to an embodiment of the present disclosure together with the flat conductor, and shows a state before the flat conductor is inserted;

FIG. 2 is a perspective view showing the electrical connector for a flat conductor together with the flat conductor, and shows a state in which connection of the flat conductor has been completed;

FIG. 3 is a perspective view showing the electrical connector for a flat conductor in a state where respective members are separated;

FIGS. 4A and 4B are views of a part of the electrical connector for a flat conductor as viewed from above, where FIG. 4A shows a state in which a movable member is at an open position, and FIG. 4B shows a state in which the movable member is at a closed position;

FIGS. 5A and 5B are views of a cross section of a part of the electrical connector for a flat conductor as viewed from above, where FIG. 5A shows a state in which the movable member is at the open position, and FIG. 5B shows a state in which the movable member is at the closed position;

FIGS. 6A and 6B are longitudinal sectional views of the electrical connector for a flat conductor before the flat conductor is inserted, where FIG. 6A shows a section at a cam portion position and FIG. 6B shows a section at a terminal position;

FIGS. 7A and 7B are perspective views of a single terminal, where FIG. 7A shows a state viewed from one surface side and FIG. 7B shows a state viewed from the other surface side;

FIGS. 8A and 8B are perspective views of a single slider, where FIG. 8A shows a state viewed from a rear side and FIG. 8B shows a state viewed from a front side;

FIGS. 9A and 9B are longitudinal sectional views of the electrical connector for a flat conductor after the flat conductor has been inserted, where FIG. 9A shows a section at the cam portion position and FIG. 9B shows a section at the terminal position;

FIGS. 10A and 10B are longitudinal sectional views of the electrical connector for a flat conductor during a rotation process of the movable member after insertion of the flat conductor, where FIG. 10A shows a section at the cam portion position and FIG. 10B shows a section at the terminal position;

FIGS. 11A and 11B are longitudinal sectional views of the electrical connector for a flat conductor in a state where connection of the flat conductor has been completed, where FIG. 11A shows a section at the cam portion position and FIG. 11B shows a section at the terminal position; and

FIGS. 12A and 12B are longitudinal sectional views of the electrical connector for a flat conductor during a process of withdrawing the flat conductor, where FIG. 12A shows a section at the cam portion position and FIG. 12B shows a section at the terminal position.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

An object of the present disclosure is to provide an electrical connector for a flat conductor that facilitates securing a sufficient elastic displacement amount in an intermediate portion of a terminal.

(1) An electrical connector for a flat conductor according to the present disclosure includes: a plurality of terminals arranged in a left-right direction; a housing that holds the plurality of terminals; a slider; and a movable member, wherein the slider is attached to the housing from a rear side to be movable in a front-rear direction, the movable member is attached to the housing to be rotatable between an open position having an orientation at a predetermined angle with respect to the front-rear direction and allowing withdrawal of a flat conductor and a closed position having an orientation along the front-rear direction and restricting withdrawal of the flat conductor, the movable member has a cam portion that rotates with rotation of the movable member, the cam portion has a pressing portion that presses the slider forward when the movable member is between the open position and the closed position, the plurality of terminals each have a held portion held by a front wall of the housing, a base arm portion, a pressing arm portion extending rearward from the base arm portion and contacting the slider, a contact arm portion extending rearward from the base arm portion and having a contact portion contacting the flat conductor, and an intermediate portion connecting the held portion and the base arm portion and elastically displaceable in the front-rear direction, when the movable member is at the open position, the slider is positioned at a first position, when the movable member is between the open position and the closed position, the slider is pressed forward by the pressing portion, and the intermediate portion urged by the pressed slider elastically displaces in a compression direction, thereby moving the slider from the first position to a second position located forward of the first position, and when the movable member is at the closed position, forward pressing of the slider by the pressing portion is released, and the slider is pushed rearward by an elastic reaction force of the intermediate portion, thereby moving the slider from the second position to a third position located rearward of the second position and forward of the first position.

To connect the flat conductor to the electrical connector for a flat conductor disclosed in (1), after the flat conductor is inserted into the connector, the movable member is operated to rotate from the open position toward the closed position. The open position is a position that allows withdrawal of the flat conductor, and the closed position is a position that restricts withdrawal of the flat conductor. When the movable member is rotated to the closed position, electrical connection between the flat conductor and the electrical connector for a flat conductor is completed. During the rotation process of the movable member from the open position to the closed position, the pressing portion of the cam portion of the movable member presses the slider forward. As a result, the slider advances from the first position (retracted position) while urging the terminal forward, and the slider is brought to the second position located forward of the first position while being accompanied by an increase in an elastic displacement amount in the compression direction of the intermediate portion of the terminal. When the movable member rotates to the closed position, forward pressing of the slider by the pressing portion is released. Therefore, urging of the terminal by the slider is released, and an elastic reaction force (restoring force) of the compressed intermediate portion is generated. The terminal pushes the slider rearward while being accompanied by a decrease in the elastic displacement amount in the compression direction of the intermediate portion, that is, while being extended. As a result, the slider retracts while being urged by the terminal, and the slider is brought to the third position (advanced position) located rearward of the second position and forward of the first position (retracted position). Accordingly, an elastic displacement amount of the intermediate portion when the slider is at the third position (advanced position) decreases as compared with an elastic displacement amount of the intermediate portion when the slider is at the second position located forward of the third position (advanced position). Therefore, in a state in which electrical connection between the flat conductor and the electrical connector for a flat conductor has been completed (a state in which the movable member is at the closed position and the slider is at the third position), it is possible to satisfactorily ensure a state in which the intermediate portion is likely to elastically displace.

(2) In the disclosure of (1), the cam portion has a notch portion formed at a position adjacent to the pressing portion, and a stepped restricted portion formed at a boundary position between the pressing portion and the notch portion, and the slider may have a stepped restricting portion engageable with the stepped restricted portion when the slider is at the third position.

With the configuration of (2), when the flat conductor is connected to the electrical connector for a flat conductor, upon rotation of the movable member to the closed position, the restricted portion of the cam portion becomes engageable with the restricting portion of the slider. Accordingly, even when an inadvertent external force acts on the movable member, the movable member can be satisfactorily retained at the closed position at which connection of the flat conductor is completed. In addition, the restricted portion and the restricting portion each have a stepped shape. Therefore, during the rotation process of the movable member, when the pressing portion passes through the position of the restricted portion, that is, when the restricted portion reaches a position engageable with the restricting portion, an operator can perceive a click feeling.

(3) In the disclosure of (1) or (2), the intermediate portion may have at least one portion curved in a plane orthogonal to the left-right direction. With this configuration, the intermediate portion can be configured to be long without an increase in size in the terminal arrangement direction (left-right direction). Therefore, a large spring length of the intermediate portion can be secured while avoiding upsizing of the electrical connector for a flat conductor in the terminal arrangement direction.

(4) In the disclosure of any one of (1) to (3), the movable member may have an engaging portion engageable with the housing when the movable member is at the open position. With this configuration, even when an inadvertent external force acts on the movable member at the open position, the movable member can be easily maintained at the open position.

According to the present disclosure, an electrical connector for a flat conductor that facilitates securing a sufficient elastic displacement amount in the intermediate portion of the terminal can be provided.

An embodiment of the present disclosure will be described below with reference to the accompanying drawings.

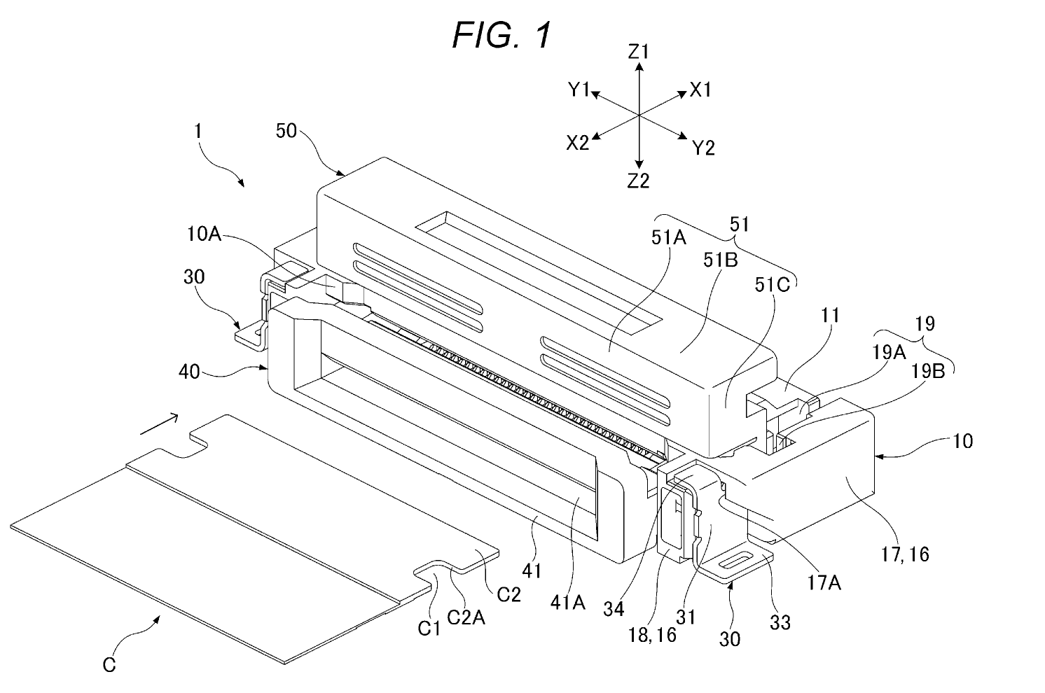

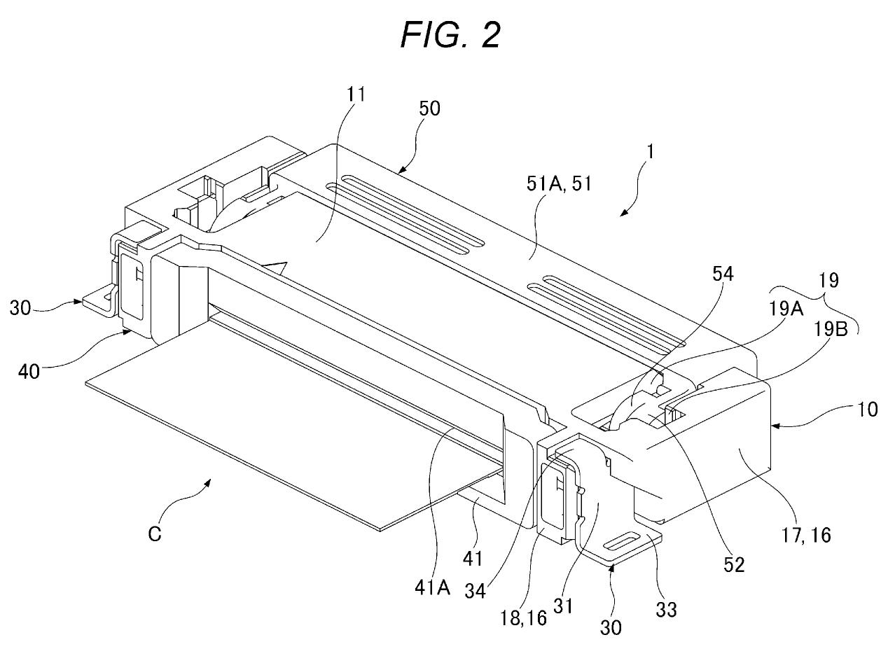

An electrical connector for a flat conductor 1 according to the embodiment of the present disclosure (hereinafter referred to as “connector 1”) is mounted on a mounting surface of a circuit board (not shown) and is configured such that a flat conductor C (for example, an FPC) is connected. As shown in FIGS. 1 and 2, the flat conductor C is insertably and removably connected to the connector 1 with a front-rear direction (X-axis direction), parallel to the mounting surface, as an insertion and withdrawal direction. The connector 1 electrically connects the circuit board and the flat conductor C by connecting the flat conductor C.

In the present embodiment, the X-axis direction is defined as the front-rear direction, an X1 direction is defined as a front direction, and an X2 direction is defined as a rear direction. In addition, a Y-axis direction is defined as a connector width direction or a left-right direction, a Y1 direction is defined as a leftward direction, and a Y2 direction is defined as a rightward direction. The Y-axis direction is orthogonal to the front-rear direction (X-axis direction) in a plane parallel to the mounting surface of the circuit board (in an XY plane). In addition, a Z-axis direction orthogonal to the mounting surface of the circuit board is defined as an up-down direction (thickness direction), a Z1 direction is defined as an upward direction, and a Z2 direction is defined as a downward direction.

The flat conductor C has a flexible strip shape extending in the front-rear direction (X-axis direction) and having the left-right direction (Y-axis direction) as a width direction. The flat conductor C includes a plurality of circuit portions (not shown) extending in the front-rear direction and arranged in the left-right direction. Each circuit portion is embedded in an insulating layer of the flat conductor C except for a front end side (X1 side) portion. The front end side portion of each circuit portion is exposed at a lower surface of the flat conductor C and is formed as a pad.

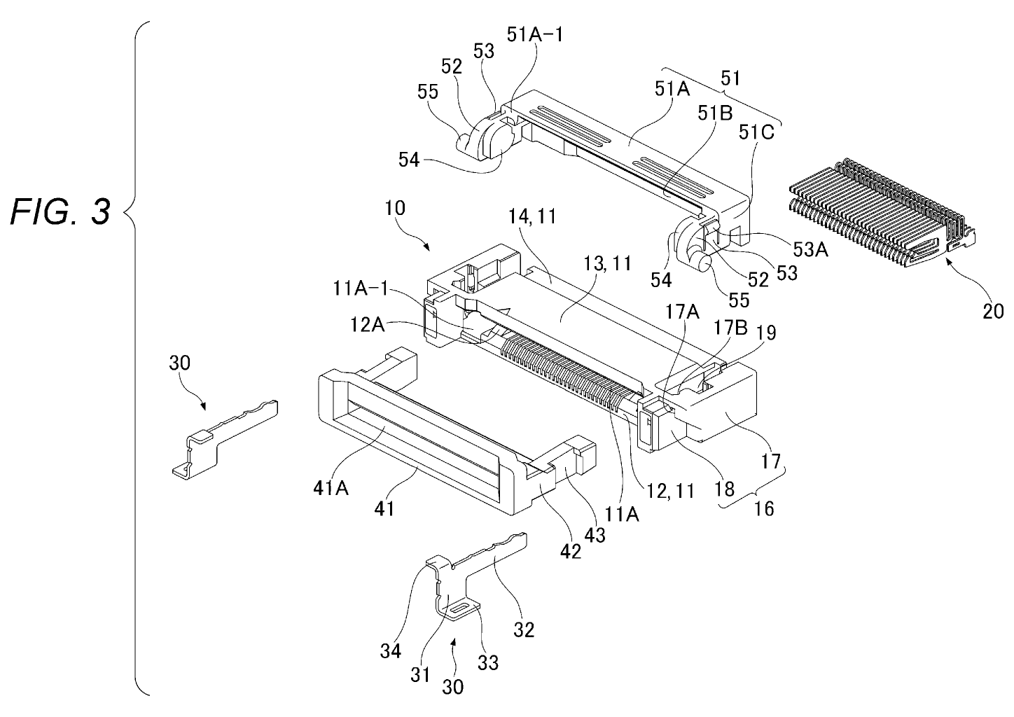

A notch portion C1 is formed in the front end side portion of the flat conductor C. The notch portion C1 is formed at each of both end portions of the flat conductor C in the left-right direction so as to receive, from below, a retention projection 12A (see FIG. 3) of a housing 10 described later provided in the connector 1. The flat conductor C also has an ear portion C2 forward of the notch portion C1, and a rear end of the ear portion C2 forms a retained portion C2A engageable with the retention projection 12A from the front.

As shown in FIGS. 1 to 3, the connector 1 has the housing 10 that receives the flat conductor C from the rear, a plurality of terminals 20, a metal fitting 30, a slider 40, and a movable member 50.

The plurality of terminals 20 are arranged in the connector width direction (Y-axis direction) as a terminal arrangement direction and are held by the housing 10. The metal fitting 30 is disposed outside a terminal arrangement range of the plurality of terminals 20 in the terminal arrangement direction and is held by the housing 10. The slider 40 is attached to the housing 10 while being movable in the front-rear direction (X-axis direction). The movable member 50 is configured to be rotatable about an axis extending in the connector width direction.

In the present embodiment, the movable member 50 is rotatable between an open position (withdrawal allowing position) that allows withdrawal of the flat conductor C as shown in FIG. 1 and a closed position (withdrawal preventing position) that restricts withdrawal of the flat conductor C as shown in FIG. 2. Hereinafter, a direction in which the movable member 50 rotates is referred to as “an opening-closing direction”. In addition, in the opening-closing direction, a direction in which the movable member 50 rotates from the closed position toward the open position is referred to as “an opening direction”, and a direction in which the movable member 50 rotates from the open position toward the closed position is referred to as “a closing direction”.

The housing 10 is made of an electrically insulating material such as resin and has a substantially rectangular parallelepiped outer shape extending with the connector width direction as a longitudinal direction, as shown in FIG. 3. The housing 10 has a main body portion 11 and side portions 16 provided on both outer sides of the main body portion 11 in the connector width direction. In addition, a side recessed portion 19 for accommodating a part of the movable member 50 is formed in the housing 10. As shown in FIGS. 1 to 4A and 4B, the side recessed portion 19 is formed in a range including a boundary position between the main body portion 11 and each side portion 16 in the connector width direction. In other words, the side recessed portion 19 is formed in a range spanning both the main body portion 11 and each side portion 16.

The main body portion 11 has a lower wall 12 and an upper wall 13 facing each other in the up-down direction, and a front wall 14 connecting front ends of the lower wall 12 and the upper wall 13. In the main body portion 11, a space surrounded by the lower wall 12, the upper wall 13, and the front wall 14 and opening rearward forms a receiving portion 11A that receives, from the rear, a part of the slider 40 and the front end side portion of the flat conductor C.

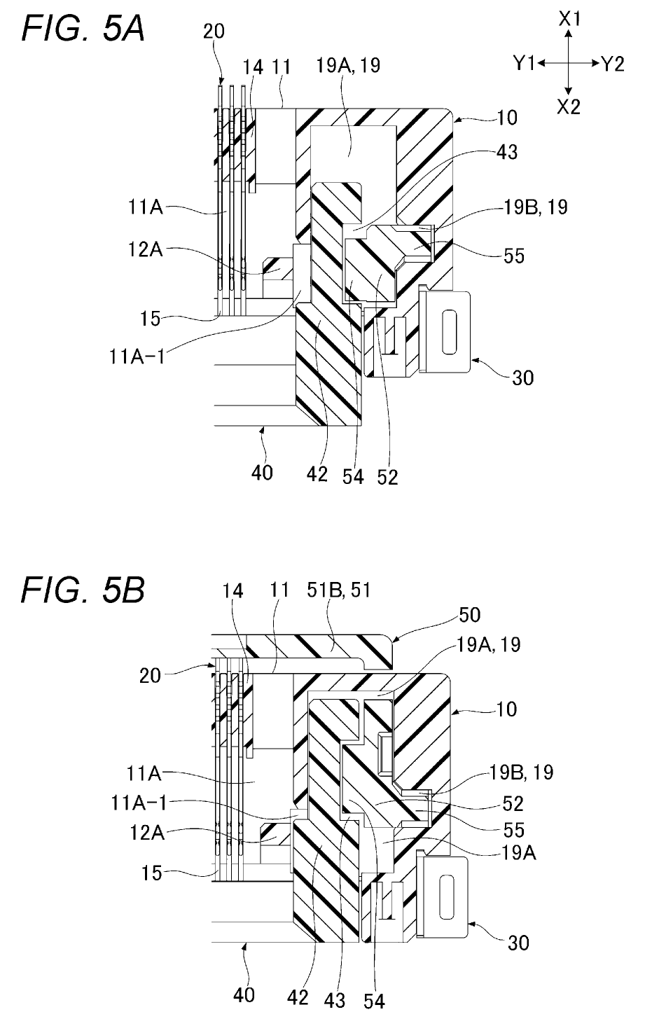

Receiving end portions 11A-1 that are both end portions of the receiving portion 11A are configured to accommodate side arm portions 42 of the slider 40. As shown in FIGS. 5A and 5B, each receiving end portion 11A-1 is formed to extend to a range of the front wall 14 in the front-rear direction. In addition, each receiving end portion 11A-1 communicates with the side recessed portion 19, and a front portion of the receiving end portion 11A-1 forms a part of the side recessed portion 19. In the lower wall 12 and the upper wall 13, groove portions extending in the front-rear direction are formed as parts of the receiving end portions 11A-1 at positions corresponding to the receiving end portions 11A-1 in the connector width direction. The receiving end portions 11A-1 can guide, with the groove portions of the lower wall 12 and the upper wall 13, the side arm portions 42 of the slider 40 in the front-rear direction while restricting movement of the side arm portions 42 in the connector width direction.

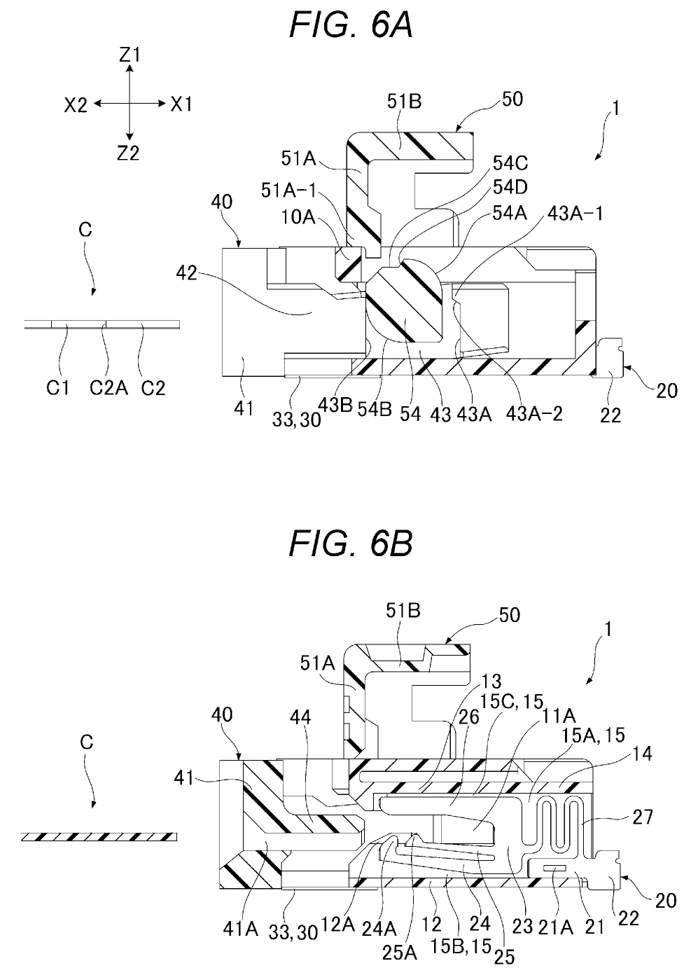

As shown in FIG. 3, the retention projection 12A protruding upward is provided on a lower inner wall surface of the receiving portion 11A, in other words, on an upper surface of the lower wall 12. The retention projection 12A is provided between a terminal arrangement range and the receiving end portion 11A-1 in the connector width direction. In addition, the retention projection 12A is provided at a position near a rear end opening of the receiving portion 11A in the front-rear direction. The retention projection 12A has a front end surface forming a flat surface orthogonal to the front-rear direction, and the front end surface is engageable with the retained portion C2A of the flat conductor C from the rear. In addition, as shown in FIG. 6B, an upper surface of a rear portion of the retention projection 12A is formed as an inclined surface inclined upward toward the front, and the inclined surface can guide the ear portion C2 of the flat conductor C inserted into the receiving portion 11A forward. On the other hand, an upper surface of a front portion of the retention projection 12A (hereinafter referred to as an “upper end surface”) is a flat surface orthogonal to the up-down direction.

The housing 10 has, at an upper portion in a range corresponding to the receiving end portion 11A-1 and the side recessed portion 19 in the connector width direction, a movement preventing portion 10A for restricting movement (rotation) of the movable member 50 in the opening direction. As shown in FIGS. 1 and 6A, the movement preventing portion 10A restricts rotation of the movable member 50 in the opening direction by supporting the movable member 50 at the open position from below.

As shown in FIGS. 5A and 5B, the main body portion 11 includes a plurality of terminal accommodating portions 15, arranged in the connector width direction, for accommodating the plurality of terminals 20. As shown in FIG. 6B, each terminal accommodating portion 15 is formed to penetrate the housing 10 in the front-rear direction.

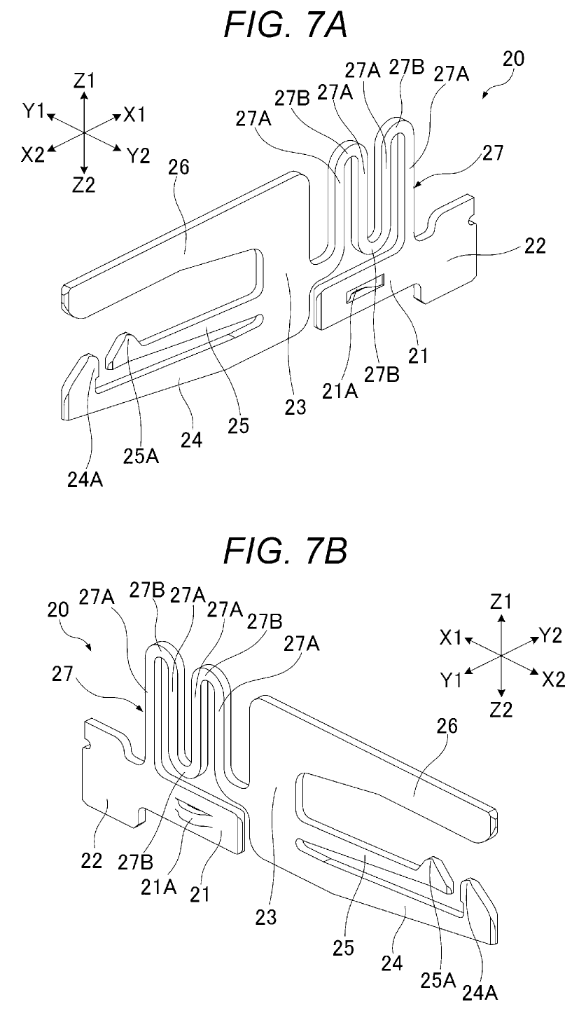

Before further detailed description of the terminal accommodating portions 15, a configuration of the terminals 20 will be described first. As shown in FIGS. 7A and 7B, each terminal 20 is made by punching a metal plate member in a plate thickness direction and is disposed in an orientation in which a plate surface is orthogonal to the connector width direction.

Each terminal 20 has, on one end side, a held portion 21 and a connection portion 22, on the other end side, a base arm portion 23, a lower contact arm portion 24, an upper contact arm portion 25, and a pressing arm portion 26, and also has an intermediate portion 27 provided between the held portion 21 (the held portion 21 and the connection portion 22) and the base arm portion 23. Hereinafter, when distinction between the lower contact arm portion 24 and the upper contact arm portion 25 is unnecessary, the lower contact arm portion 24 and the upper contact arm portion 25 may be collectively referred to as “contact arm portions 24 and 25” for convenience of description.

As shown in FIG. 6B, the held portion 21 extends in the front-rear direction along a lower inner wall surface of the terminal accommodating portion 15 within a range of the front wall 14 in the front-rear direction. As shown in FIG. 7B, the held portion 21 is provided with a press-fit projection 21A protruding from a plate surface on a Y1 side. The press-fit projection 21A is formed, for example, by embossing. The held portion 21 is held by press-fitting the press-fit projection 21A into a lateral inner wall surface of the terminal accommodating portion 15 (an inner wall surface orthogonal to the connector width direction).

As shown in FIG. 6B, the connection portion 22 extends forward from a front end of the held portion 21 and is positioned outside the housing 10. A lower end portion of the connection portion 22 is positioned slightly below a lower surface of the housing 10 and is configured to be solder-connected to a corresponding circuit portion of the circuit board.

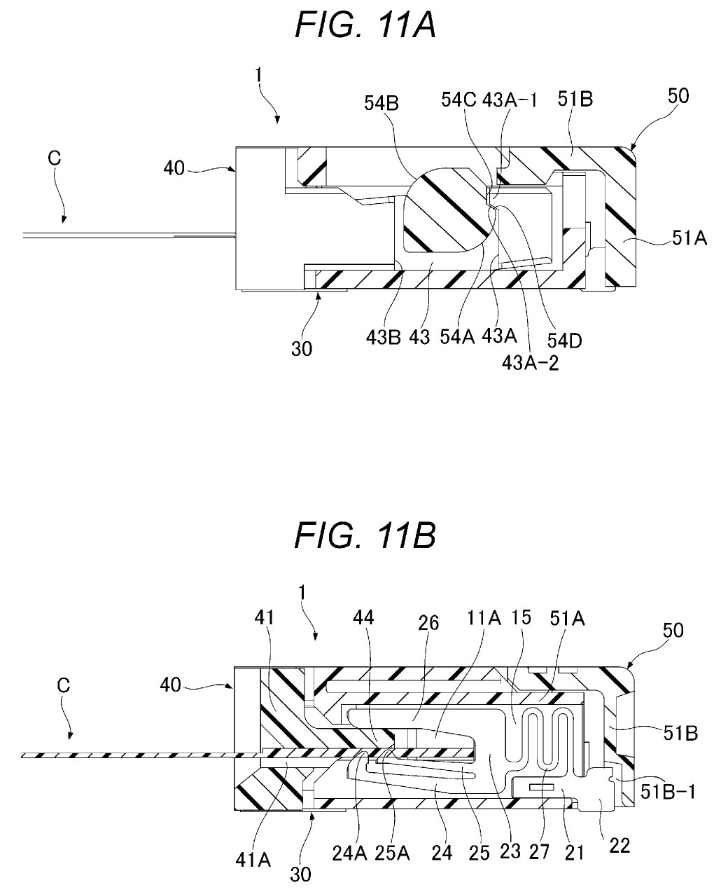

As shown in FIG. 6B, the base arm portion 23 is located within the range of the front wall 14 in the front-rear direction and extends in the up-down direction. The contact arm portions 24 and 25 extend rearward along the lower wall 12 from a lower portion of the base arm portion 23 and are elastically displaceable in the up-down direction. A rear contact portion 24A protruding upward is formed at a rear end of the lower contact arm portion 24. The upper contact arm portion 25 is provided above the lower contact arm portion 24 and is formed shorter than the lower contact arm portion 24. A front contact portion 25A protruding upward at a position forward of the rear contact portion 24A is formed at a rear end of the upper contact arm portion 25. Hereinafter, when distinction between the rear contact portion 24A and the front contact portion 25A is unnecessary, the rear contact portion 24A and the front contact portion 25A may be collectively referred to as “contact portions 24A and 25A” for convenience of description. The contact arm portions 24 and 25 are configured to elastically displace downward and to contact, with contact pressure, the circuit portions of the flat conductor C from below at the contact portions 24A and 25A (see FIG. 11B).

As shown in FIG. 6B, the pressing arm portion 26 extends rearward along the upper wall 13 of the housing 10 from an upper portion of the base arm portion 23 to substantially the same position as the rear end of the lower contact arm portion 24. The pressing arm portion 26 is configured to indirectly press the flat conductor C from above toward the contact portions 24A and 25A via a pressing plate portion 44 of the slider 40 (see FIG. 11B). In the present embodiment, the pressing arm portion 26 is positioned above the contact arm portions 24 and 25 in the up-down direction and is formed thicker than the contact arm portions 24 and 25.

As shown in FIG. 6B, the intermediate portion 27 is located directly above the held portion 21 and is located within the range of the held portion 21 in the front-rear direction. With the intermediate portion 27 provided in the range of the held portion 21 in this manner, upsizing of the terminal 20 in the front-rear direction can be avoided. In addition, most of the intermediate portion 27 overlaps the base arm portion 23 in the up-down direction. With the intermediate portion 27 provided to have a range overlapping the base arm portion 23 in this manner, upsizing of the terminal 20 in the up-down direction can be avoided.

The intermediate portion 27 has a plurality of portions (curved portions 27B) curved in a plane (XZ plane) orthogonal to the connector width direction. The intermediate portion 27 is provided between the held portion 21 and the base arm portion 23. Specifically, the intermediate portion 27 meanders in the XZ plane and connects a rear end portion of the held portion 21 and a lower portion of the base arm portion 23. The intermediate portion 27 has a shape in which two substantially inverted U-shaped portions and one substantially U-shaped portion are continuous. Specifically, as shown in FIGS. 7A and 7B, the intermediate portion 27 has four leg portions 27A extending in the up-down direction and three curved portions 27B each connecting adjacent upper end portions or adjacent lower end portions in the front-rear direction. The intermediate portion 27 is elastically displaceable in any of the front-rear direction, the connector width direction, and the up-down direction. In the present embodiment, since the intermediate portion 27 is provided with the curved portions 27B, a full length of the intermediate portion 27 can be secured to be long without increasing the size of the intermediate portion 27 in the connector width direction and the up-down direction. Therefore, a large elastic displacement amount in the intermediate portion 27 and consequently in the terminal 20 can be secured. The numbers of the leg portions 27A and the curved portions 27B in the intermediate portion 27 can be appropriately set.

Description returns to the terminal accommodating portions 15 of the housing 10. Each terminal accommodating portion 15 is formed as a slit-shaped groove portion extending in a direction orthogonal to the connector width direction (Y-axis direction). As shown in FIG. 6B, each terminal accommodating portion 15 has a front accommodating portion 15A formed in the front wall 14, a lower accommodating portion 15B formed in the lower wall 12, and an upper accommodating portion 15C formed in the upper wall 13.

The front accommodating portion 15A extends in the up-down direction in the front wall 14 and accommodates the held portion 21, the base arm portion 23, and the intermediate portion 27 of the terminal 20. In a state where the intermediate portion 27 is accommodated in the front accommodating portion 15A, gaps are formed between the intermediate portion 27 and an inner wall surface of the front accommodating portion 15A in the front-rear direction, the connector width direction, and the up-down direction, and the intermediate portion 27 is elastically displaceable in these three directions.

The lower accommodating portion 15B is recessed from an upper surface of the lower wall 12 and extends in the front-rear direction, and accommodates portions of the contact arm portions 24 and 25 other than the contact portions 24A and 25A. The upper accommodating portion 15C is recessed from a lower surface of the upper wall 13 and extends in the front-rear direction, and accommodates portions of the pressing arm portion 26 other than a lower end portion thereof.

The terminals 20 are attached to and accommodated in the terminal accommodating portions 15 from the front. Specifically, each terminal 20 is accommodated in the terminal accommodating portion 15 and held by the housing 10 by press-fitting the held portion 21 into a lower portion of the front accommodating portion 15A from the front. When the terminal 20 is attached to the housing 10, as shown in FIG. 6B, the contact portions 24A and 25A of the terminal 20 protrude upward from the lower accommodating portion 15B and are positioned in the receiving portion 11A, and the lower end portion of the pressing arm portion 26 protrudes downward from the upper accommodating portion 15C and is positioned in the receiving portion 11A.

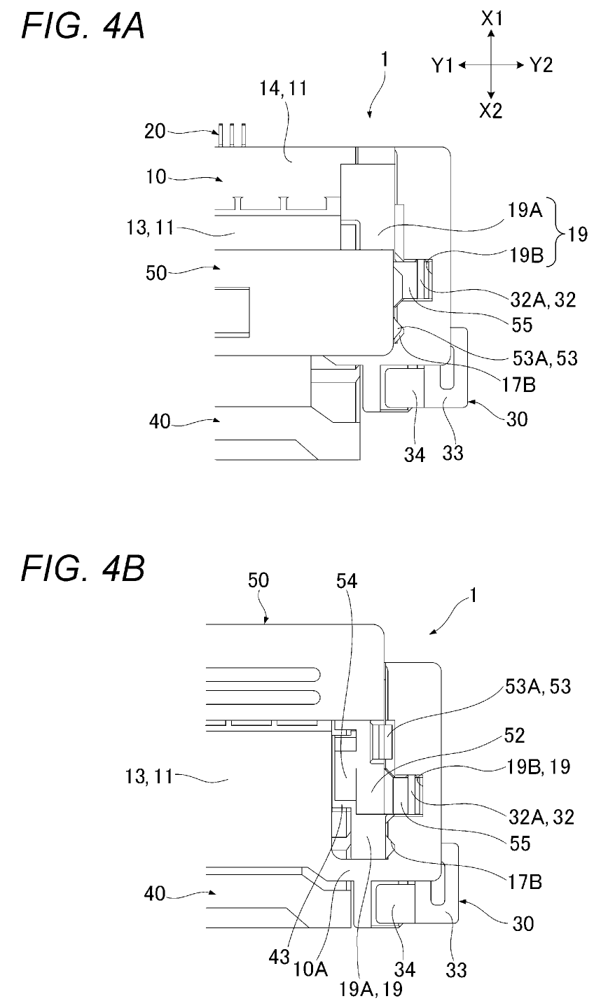

As shown in FIG. 3, the side portion 16 of the housing 10 has a side wall 17 located within the range of the main body portion 11 in the front-rear direction, and a projecting wall 18 protruding rearward from the side wall 17. A metal fitting holding groove portion 17A, which press-fits and holds a part of the metal fitting 30, specifically a held arm portion 32, is formed in the side wall 17 to extend in the front-rear direction. In addition, an engaged portion 17B engageable with the movable member 50 at the open position is formed in a rear portion of the side wall 17. As shown in FIGS. 4A and 4B, the engaged portion 17B is recessed in a substantially triangular shape from an inner surface of the side wall 17 and has a groove shape extending in the up-down direction. As shown in FIG. 4A, the engaged portion 17B maintains the movable member 50 at the open position by engaging with an engaging portion 53 of the movable member 50 at the open position.

As shown in FIG. 3, the projecting wall 18 is provided at a position closer to an inner side than an outer surface of the side wall 17, within the range of the side wall 17 in the connector width direction. An upper surface of the projecting wall 18 is located at a lower position by being recessed slightly from an upper surface of the side wall 17.

As shown in FIGS. 4A and 4B, the side recessed portion 19 has a side groove portion 19A and a shaft accommodating portion 19B. The side groove portion 19A accommodates an extending plate portion 52, the engaging portion 53, and a cam portion 54 of the movable member 50. The shaft accommodating portion 19B accommodates a shaft portion 55 of the movable member 50. The side groove portion 19A is recessed from an upper surface of the side wall 17, has a groove shape extending in the front-rear direction, and is open to the front. The shaft accommodating portion 19B is recessed from an inner surface of the side wall 17, namely, a surface on the side groove portion 19A side (a surface orthogonal to the connector width direction), extends in the up-down direction, and is open upward.

The metal fitting 30 is formed by bending a metal plate member in a plate thickness direction. As shown in FIG. 3, the metal fitting 30 has a base portion 31, the held arm portion 32, a fixing portion 33, and a restricting piece portion 34. The held arm portion 32 extends forward from an upper portion of the base portion 31. The fixing portion 33 is bent at a lower end of the base portion 31 and extends outward in the connector width direction. The restricting piece portion 34 is bent at an upper end of the base portion 31 and extends inward in the connector width direction.

The base portion 31 is disposed along an outer surface of the projecting wall 18 in the connector width direction (a surface orthogonal to the connector width direction). The held arm portion 32 extends straight forward from a front end of the upper portion of the base portion 31 and is held by being press-fitted into the metal fitting holding groove portion 17A of the housing 10 from the rear. As shown in FIGS. 4A and 4B, an intermediate portion of the held arm portion 32 in the front-rear direction is positioned in the shaft accommodating portion 19B. The intermediate portion of the held arm portion 32 is positioned directly above the shaft portion 55 of the movable member 50 and forms a shaft restricting portion 32A that restricts upward movement of the shaft portion 55.

The fixing portion 33 is positioned slightly below a bottom surface of the housing 10, extends along a circuit board (not shown), and is configured to be fixed to a corresponding portion of the circuit board by solder connection. The restricting piece portion 34 is disposed directly above the projecting wall 18 along the upper surface of the projecting wall 18. Therefore, for example, when an inadvertent external force acts to lift the housing 10 upward during withdrawal of the flat conductor C, the restricting piece portion 34 abuts the projecting wall 18 from above, thereby allowing restriction of movement of the housing 10.

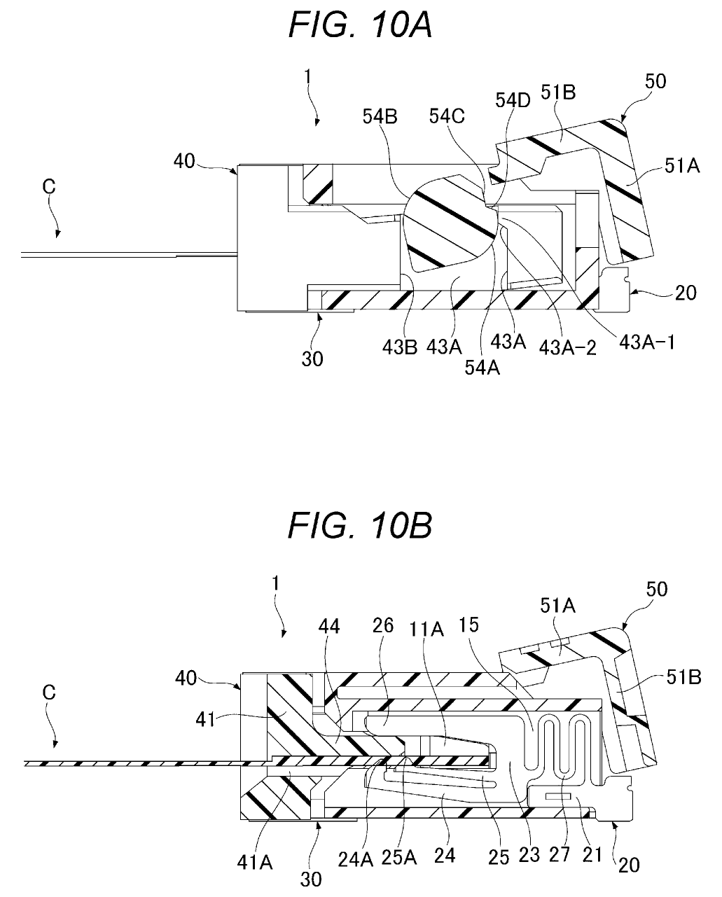

The slider 40 is attached to the housing 10 while being movable in the front-rear direction within a range including a retracted position that allows withdrawal of the flat conductor C (see FIGS. 1, 6A, and 6B) and an advanced position that restricts withdrawal of the flat conductor C (see FIGS. 2, 11A, and 11B). Specifically, the slider 40 is movable between the retracted position and a position located forward of the advanced position (see FIGS. 10A and 10B).

The slider 40 is positioned at the retracted position when the movable member 50 is at the open position, and the slider 40 is positioned at the advanced position located forward of the retracted position when the movable member 50 is at the closed position. The advanced position of the slider 40 is a position of the slider 40 when connection between the flat conductor C and the connector 1 has been completed (connection completion position). The slider 40 is configured to move forward of the advanced position when the movable member 50 is between the open position and the closed position.

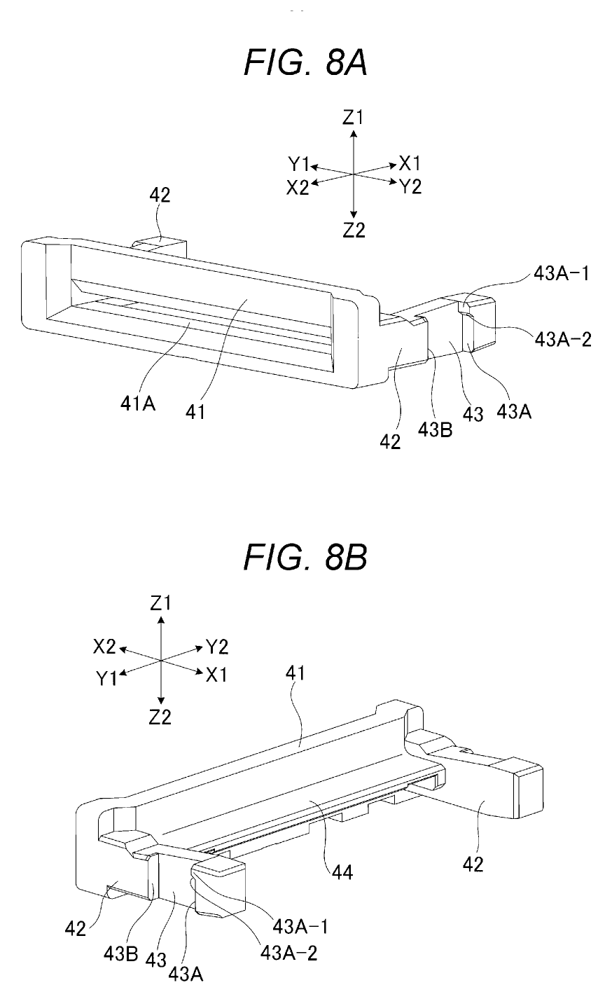

The slider 40 is made of an electrically insulating material such as resin and has a base portion 41 extending in the connector width direction, the side arm portions 42, and the pressing plate portion 44, as shown in FIGS. 3, 8A, and 8B. The side arm portions 42 extend forward (X1 direction) from both end portions of the base portion 41 in the connector width direction. The pressing plate portion 44 is provided between the two side arm portions 42 and extends forward from the base portion 41.

As shown in FIGS. 1 and 2, the base portion 41 is provided to extend in the connector width direction over substantially the same range as the main body portion 11 of the housing 10 when viewed along the front-rear direction. An insertion hole portion 41A penetrating the base portion 41 in the front-rear direction is formed in a range of the base portion 41 corresponding to the receiving portion 11A of the main body portion 11. The insertion hole portion 41A has a slit shape extending in the connector width direction in a central region of the base portion 41 and allows insertion of the flat conductor C.

Each side arm portion 42 has a cam accommodating portion 43 for accommodating the cam portion 54 of the movable member 50. As shown in FIGS. 3, 8A, and 8B, the cam accommodating portion 43 is formed at an intermediate position of the side arm portion 42 in the front-rear direction by being recessed from an outer surface of the side arm portion 42 and by penetrating the side arm portion 42 in the up-down direction. The cam accommodating portion 43 is configured to receive pressing forces from the cam portion 54 in the front-rear direction at a front inner wall surface and a rear inner wall surface. Specifically, a portion having, as a rear surface, the front inner wall surface of the cam accommodating portion 43 (a surface orthogonal to the front-rear direction) forms a front pressed portion 43A that receives a forward pressing force from the cam portion 54. A portion having, as a front surface, the rear inner wall surface of the cam accommodating portion 43 (a surface orthogonal to the front-rear direction) forms a rear pressed portion 43B that receives a rearward pressing force from the cam portion 54.

A projection 43A-1 protruding rearward is formed at an upper portion of the front pressed portion 43A. The front pressed portion 43A receives the forward pressing force from the cam portion 54 at a rear surface of the projection 43A-1. The rear surface of the projection 43A-1 and the rear surface of the front pressed portion 43A excluding the projection 43A-1 are flat surfaces (planar surfaces) orthogonal to the front-rear direction. In the front pressed portion 43A, a step portion formed at a boundary position between the projection 43A-1 and the front pressed portion 43A excluding the projection 43A-1 forms a restricting portion 43A-2 engageable with the cam portion 54 of the movable member 50 in a movement direction (rotation direction) of the movable member 50. As shown in FIG. 11A, when the movable member 50 is at the closed position and the slider 40 is at the advanced position, the restricting portion 43A-2 is an inclined surface inclined downward toward the front from a lower end of the rear surface of the projection 43A-1. In addition, a front surface of the rear pressed portion 43B is a flat surface (planar surface) orthogonal to the front-rear direction.

As shown in FIGS. 6B and 8B, the pressing plate portion 44 is located above the insertion hole portion 41A of the base portion 41, extends in the connector width direction, and connects inner side surfaces of rear portions of the two side arm portions 42 to each other. In the terminal arrangement range in the connector width direction, the pressing plate portion 44 enters, from the rear, between the contact portions 24A and 25A and the pressing arm portion 26 of the terminal 20 when the slider 40 is at the advanced position (see FIG. 11B). At this time, the pressing plate portion 44 receives a pressing force from the pressing arm portion 26 from above and presses an upper surface of the flat conductor C downward, thereby increasing contact pressure between the flat conductor C and the contact portions 24A and 25A. In addition, at both end portions in the connector width direction, the pressing plate portion 44 is located directly above the retention projection 12A of the housing 10 and the flat conductor C when the slider 40 is at the advanced position, and abuts the upper surface of the flat conductor C to restrict upward movement of the flat conductor C.

As shown in FIG. 3, the movable member 50 has an operation portion 51 extending in the connector width direction, and the extending plate portions 52, the engaging portions 53, the cam portions 54, and the shaft portions 55 provided at both end portions of the movable member 50 in the connector width direction.

The movable member 50 is rotatable between the open position (see, for example, FIG. 1) having an orientation at a predetermined angle with respect to the front-rear direction and the closed position (see, for example, FIG. 2) having an orientation along the front-rear direction. In the present embodiment, the movable member 50 stands upright at the open position, and therefore a rotation angle of the movable member 50 between the open position and the closed position is 90 degrees. However, the movable member 50 may be non-upright at the open position, and the rotation angle may be other than 90 degrees.

As shown in FIG. 3, the operation portion 51 has, in an orientation where the movable member 50 is at the closed position, a plate-shaped upper plate portion 51A having the up-down direction as a plate thickness direction, a front plate portion 51B extending downward from a front end of the upper plate portion 51A and having the front-rear direction as a plate thickness direction, and side plate portions 51C connected to end portions of the upper plate portion 51A and the front plate portion 51B in the connector width direction and having the connector width direction as a plate thickness direction. The operation portion 51 is configured to receive a rotation operation (opening-closing operation) in the opening-closing direction.

As shown in FIG. 3, the extending plate portion 52 extends rearward from the side plate portion 51C in an orientation where the movable member 50 is at the closed position, and has a plate shape having the connector width direction as a plate thickness direction. The extending plate portion 52 is formed in a substantially rectangular shape when viewed along the connector width direction. An upper-end-side corner portion of a rear portion of the extending plate portion 52 at the closed position has an arc shape.

As shown in FIG. 3, the extending plate portion 52 is positioned slightly shifted downward relative to the upper plate portion 51A of the movable member 50 at the closed position. A step portion formed at a boundary position with the extending plate portion 52 at a rear end portion of the upper plate portion 51A forms a supported portion 51A-1 supported by the movement preventing portion 10A of the housing 10 when the movable member 50 is at the open position (see FIG. 6A).

As shown in FIG. 3, the engaging portion 53 is provided at a front portion of the extending plate portion 52 of the movable member 50 at the closed position. A recessed portion recessed from an outer surface (a surface positioned outward in the connector width direction) is formed at a front portion of the extending plate portion 52, and the engaging portion 53 extends upward from a lower portion of the extending plate portion 52 in a state where a part of the engaging portion 53 is accommodated in the recessed portion, thereby forming an arm shape elastically displaceable in the connector width direction. An engaging projection 53A protruding outward in the connector width direction is formed at an upper end portion of the engaging portion 53. As shown in FIG. 4A, the engaging projection 53A has a substantially triangular shape when viewed along the up-down direction (Z-axis direction) when the movable member 50 is at the open position, and the engaging projection 53A is configured to engage with the engaged portion 17B of the housing 10.

As shown in FIG. 3, the cam portion 54 is provided to protrude inward in the connector width direction from an inner surface of the extending plate portion 52 (a surface positioned inward in the connector width direction). As shown in FIGS. 4B, 5A, and 5B, the cam portion 54 is accommodated in the cam accommodating portion 43 of the slider 40. The cam portion 54 rotates with rotation of the movable member 50.

A shape of the cam portion 54 will be described in detail below with reference to FIG. 6A showing the cam portion 54 at the open position and FIG. 11A showing the cam portion 54 at the closed position. As shown in FIGS. 6A and 11A, the cam portion 54 is formed in a substantially rectangular shape when viewed along the connector width direction. When viewed along the connector width direction, the cam portion 54 has an arc shape at a first corner portion positioned at an upper-end side of a front portion in FIG. 6A (a corner portion positioned at a lower-end side of the front portion in FIG. 11A) and at a second corner portion positioned at a lower-end side of a rear portion in FIG. 6A (a corner portion positioned at an upper-end side of the rear portion in FIG. 11A).

On a peripheral surface of the cam portion 54 (a surface parallel to the connector width direction), a convex curved surface formed at the first corner portion forms a front pressing portion 54A. When the movable member 50 rotates in the closing direction from the open position toward the closed position, the front pressing portion 54A presses the front pressed portion 43A of the slider 40 forward, thereby moving the slider 40 forward. On the other hand, on the peripheral surface of the cam portion 54, a convex curved surface formed at the second corner portion forms a rear pressing portion 54B. When the movable member 50 rotates in the opening direction from the closed position toward the open position, the rear pressing portion 54B presses the rear pressed portion 43B of the slider 40 rearward, thereby moving the slider 40 rearward.

In addition, as shown in FIG. 6A, in the cam portion 54 at the open position, a notch portion 54C formed by cutting out a peripheral surface of the cam portion 54 is formed in a third corner portion positioned at an upper-end side of a rear portion (a corner portion positioned at an upper-end side of a front portion in FIG. 11A), in other words, a portion located rearward of the front pressing portion 54A and adjacent to the front pressing portion 54A. In addition, a stepped restricted portion 54D is formed at a boundary position between the front pressing portion 54A and the notch portion 54C. As shown in FIG. 11A, when the movable member 50 is at the closed position and the slider 40 is at the advanced position, the restricted portion 54D is an inclined surface inclined downward toward the front from a lower end of the notch portion 54C. The restricted portion 54D is engageable with the restricting portion 43A-2 of the slider 40 in the opening direction, namely, from a lower side. At this time, the front pressing portion 54A and the restricting portion 43A-2 are engaged with each other by inclined surfaces inclined downward toward the front.

As shown in FIG. 3, the shaft portion 55 is provided to protrude outward in the connector width direction from an outer surface of the extending plate portion 52. The shaft portion 55 has a cylindrical shape having an axis extending in the connector width direction and is accommodated in the shaft accommodating portion 19B of the housing 10 while being rotatable about the axis. Movement of the shaft portion 55 forward, rearward, and downward is restricted by an inner wall surface of the shaft accommodating portion 19B, and movement of the shaft portion 55 upward is restricted by the shaft restricting portion 32A of the metal fitting 30.

An assembly procedure of the connector 1 will be described. First, the terminals 20 are attached to the housing 10 from the front. Specifically, the held portion 21 of the terminal 20 is press-fitted into the front accommodating portion 15A of the housing 10 from the front to accommodate the terminal 20 in the terminal accommodating portion 15. In addition, the slider 40 is attached to the housing 10 from the rear. Specifically, the side arm portions 42 of the slider 40 are inserted into the receiving end portions 11A-1 of the housing 10 from the rear. The attachment operation of the slider 40 is performed until the slider 40 is placed at the retracted position. The terminals 20 and the slider 40 may be attached to the housing 10 in any order, or simultaneously.

Next, the movable member 50 maintained in an orientation at the open position is attached to the housing 10 from above. Specifically, the cam portion 54 is accommodated in the cam accommodating portion 43 of the slider 40, and the shaft portion 55 is accommodated in the shaft accommodating portion 19B of the housing 10. At this time, in the cam accommodating portion 43 of the slider 40, the cam portion 54 of the movable member 50 is positioned to be contactable with the rear pressed portion 43B from the front and is positioned to be contactable with the front pressed portion 43A from the rear. Therefore, the slider 40 is restrained from coming out rearward from the housing 10.

Next, the metal fitting 30 is attached to the housing 10 from the rear. Specifically, the held arm portion 32 of the metal fitting 30 is press-fitted into the metal fitting holding groove portion 17A of the housing 10 from the rear. By attaching the metal fitting 30 to the housing 10 in this manner, the shaft restricting portion 32A of the metal fitting 30 is positioned directly above the shaft portion 55 of the movable member 50 and restricts upward movement of the shaft portion 55. As a result, separation of the movable member 50 from the housing 10 can be satisfactorily restrained. The connector 1 is completed by attaching the metal fitting 30 to the housing 10 in this manner.

Next, insertion and withdrawal operations of the flat conductor C with respect to the connector 1 will be described. First, before starting an insertion operation of the flat conductor C, the connection portions 22 of the terminals 20 and the fixing portions 33 of the metal fittings 30 are solder-connected to corresponding portions (not shown) of a circuit board to mount the connector 1 on the circuit board. In addition, the movable member 50 is placed at the open position. The supported portion 51A-1 of the movable member 50 at the open position is supported from below by the movement preventing portion 10A of the housing 10. This configuration restricts movement of the movable member 50 at the open position further in the opening direction.

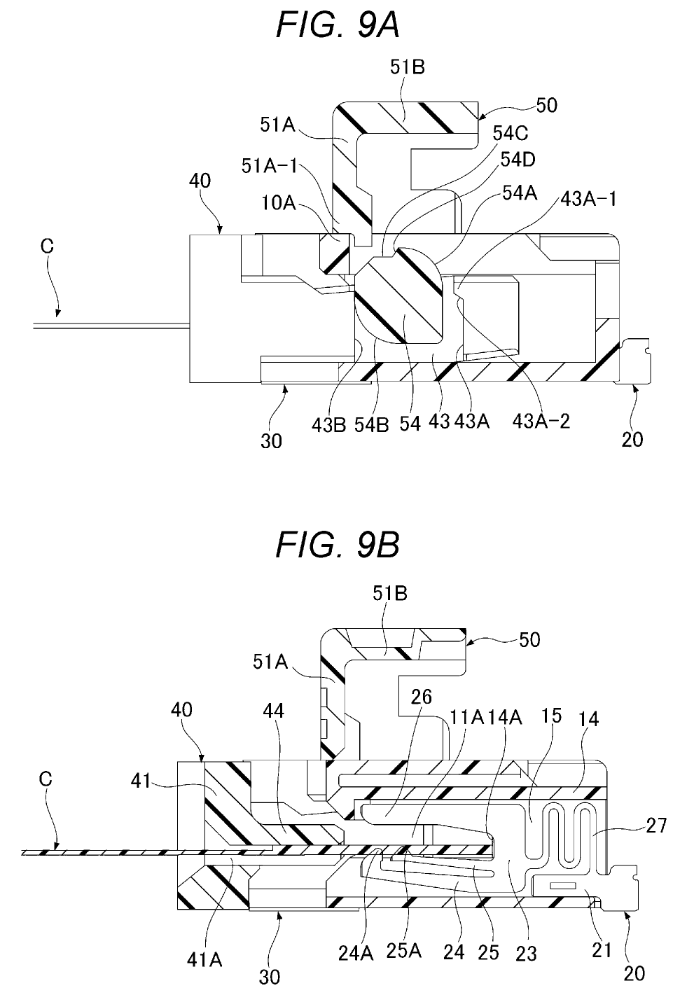

Next, as shown in FIGS. 1, 6A, and 6B, the flat conductor C is positioned rearward of the connector 1 such that a plate surface of the flat conductor C is parallel to the front-rear direction and the left-right direction. Next, as shown in FIGS. 9A and 9B, the front end side portion of the flat conductor C is inserted forward through the insertion hole portion 41A of the slider 40 and is further inserted forward into the receiving portion 11A of the housing 10. During the insertion into the receiving portion 11A, the flat conductor C enters between the contact arm portions 24 and 25 and the pressing arm portion 26 of the terminal 20, as shown in FIG. 9B.

The insertion of the flat conductor C is completed when a front end of the flat conductor C abuts a rear surface 14A of the front wall 14 of the housing 10. At this time, the contact arm portions 24 and 25 of the terminals 20 are in a free state. In addition, a dimension (a dimension in the up-down direction) of a gap formed between the flat conductor C supported by the contact portions 24A and 25A and the pressing arm portion 26 is slightly smaller than a thickness dimension (a dimension in the up-down direction) of the pressing plate portion 44 of the slider 40. In FIG. 9B, the flat conductor C is shown to overlap the contact portions 24A and 25A, but the flat conductor C is actually placed on the contact portions 24A and 25A.

In addition, at both end portions of the flat conductor C in the connector width direction, the ear portion C2 is guided by the inclined surface of the retention projection 12A of the housing 10 to ride onto the upper end surface, then advances further to pass the position of the retention projection 12A, and reaches a position forward of the retention projection 12A. Therefore, when the insertion of the flat conductor C has been completed, the retention projection 12A is positioned in the notch portion C1 of the flat conductor C.

Next, a finger is hooked on the operation portion 51 of the movable member 50 at the open position, and the movable member 50 is rotated in the closing direction with an operation force larger than an engagement force between the engaging portion 53 and the engaged portion 17B to move the movable member 50 to the closed position. At this time, elastic displacement of the engaging portion 53 inward in the connector width direction releases the engaged state between the engaging portion 53 and the engaged portion 17B and allows rotation of the movable member 50 in the closing direction.

During a rotation process in the closing direction, when the movable member 50 is within a predetermined rotation range (movement range), the front pressing portion 54A of the cam portion 54 presses the projection 43A-1 of the slider 40 forward while sliding in contact with a rear surface of the projection 43A-1. Here, the “predetermined rotation range” is a rotation range in which the front pressing portion 54A of the movable member 50 is in sliding contact with the rear surface of the projection 43A-1 of the slider 40. The predetermined rotation range may be an entire rotation range between the open position and the closed position or may be a part of the rotation range between the open position and the closed position.

As a result of pressing of the projection 43A-1 by the front pressing portion 54A, the slider 40 moves forward in interlock with rotation of the movable member 50. At this time, the pressing plate portion 44 of the slider 40 enters from the rear between the pressing arm portion 26 of the terminal 20 and the flat conductor C while widening a gap between the pressing arm portion 26 and the flat conductor C. As a result, the pressing plate portion 44 of the slider 40 is in a state where an upper surface contacts the pressing arm portion 26 and a lower surface contacts an upper surface of the flat conductor C. Entry of the pressing plate portion 44 is allowed by downward elastic displacement of the contact arm portions 24 and 25 of the terminal 20.

When the slider 40 advances, a forward external force acts on the pressing arm portion 26 due to a frictional force with the pressing plate portion 44. When the external force acts on the pressing arm portion 26, the terminal 20 is urged forward. As a result, the intermediate portion 27 of the terminal 20 is elastically displaced and compressed in the front-rear direction, and the base arm portion 23, the contact arm portions 24 and 25, and the pressing arm portion 26 of the terminal 20 advance together with the slider 40.

As shown in FIG. 10A, the front pressing portion 54A at a portion adjacent to the restricted portion 54D in the opening-closing direction presses the projection 43A-1 forward. At this time, as shown in FIG. 10B, an elastic displacement amount (compression amount) of the intermediate portion 27 in the front-rear direction becomes maximum, and the slider 40 advances to a maximum and is brought forward of the advanced position. At this time, abutment of a lower portion of the base arm portion 23 against a rear end of the held portion 21 restricts excessive advance of the base arm portion 23, the contact arm portions 24 and 25, and the pressing arm portion 26. In FIG. 10B, the contact arm portions 24 and 25 are shown in a state without elastic displacement, but the contact arm portions 24 and 25 are actually elastically displaced downward.

Substantially simultaneously with further rotation of the movable member 50 in the closing direction to reach the closed position, the front pressing portion 54A passes the position of the projection 43A-1, and the projection 43A-1 is positioned in the notch portion 54C as shown in FIG. 11A. At this time, forward urging of the terminal 20 by the slider 40 is released, and an elastic reaction force (restoring force) of the intermediate portion 27 is generated. As a result, the slider 40 retracts while being urged by the terminal 20 due to a frictional force between the pressing plate portion 44 and the pressing arm portion 26, and the slider 40 is brought to the advanced position while being accompanied by a decrease in the elastic displacement amount of the intermediate portion 27. At this time, as shown in FIG. 11B, the base arm portion 23, the contact arm portions 24 and 25, and the pressing arm portion 26 also retract together with the slider 40, and the base arm portion 23 is brought to a position separated from the held portion 21. In a state where the slider 40 is at the advanced position, the intermediate portion 27 may return to a free state (a state where elastic displacement has been eliminated), or the intermediate portion 27 may be in a state elastically displaced slightly in a compression direction without returning to the free state (a state where elastic displacement in the compression direction has decreased).

In addition, as shown in FIG. 11A, the restricted portion 54D of the cam portion 54 is engageable with the restricting portion 43A-2 of the slider 40 in the opening direction, namely, from the lower side. Accordingly, even when an inadvertent external force acts on the movable member 50, the movable member 50 can be satisfactorily retained at the closed position. In addition, the restricted portion 54D and the restricting portion 43A-2 have a stepped shape. Therefore, during the rotation process of the movable member 50, when the front pressing portion 54A passes the position of the projection 43A-1, namely, when the restricted portion 54D reaches a position engageable with the restricting portion 43A-2, an operator can perceive a click feeling.

In addition, as shown in FIG. 11B, the front plate portion 51B of the movable member 50 is positioned to face, from the front, a front surface of the front wall 14 of the housing 10. At this time, a lower end of the front plate portion 51B is positioned at substantially the same height as a lower end of the housing 10 and covers the connection portion 22 of the terminal 20. Accordingly, the connection portion 22 is protected from the outside, and for example, adhesion of dust to the connection portion 22 and contact of an operator’s finger with the connection portion 22 are satisfactorily suppressed. In addition, in the present embodiment, as shown in FIG. 11B, a recessed portion 51B-1 is formed in an inner surface of a lower end portion of the front plate portion 51B at a position corresponding to the connection portion 22, and interference between the connection portion 22 and the front plate portion 51B is satisfactorily avoided.

In addition, when the slider 40 retracts to reach the advanced position, both end portions of the pressing plate portion 44 in the connector width direction are positioned directly above the retention projections 12A. Since the pressing plate portion 44 restricts upward movement of the flat conductor C, the retained portion C2A of the flat conductor C is maintained at a position engageable with the retention projection 12A from the front. Accordingly, inadvertent withdrawal of the flat conductor C is satisfactorily restricted.

In addition, as shown in FIG. 11B, in the terminal arrangement range in the connector width direction, the pressing plate portion 44 of the slider 40 enters between the pressing arm portion 26 of the terminal 20 and the flat conductor C and receives a downward pressing force from the pressing arm portion 26. The pressing force is transmitted to the flat conductor C via the pressing plate portion 44, the contact portions 24A and 25A are further pressed by the flat conductor C, and a state where the contact arm portions 24 and 25 are elastically displaced downward is maintained. As a result, the contact portions 24A and 25A contact circuit portions of the flat conductor C from below with contact pressure. The pressing plate portion 44 and the flat conductor C are sandwiched by the pressing arm portion 26 and the contact arm portions 24 and 25. In addition, abutment of the pressing plate portion 44 against the upper surface of the flat conductor C restricts upward movement of the flat conductor C. In FIG. 11B, the contact arm portions 24 and 25 are shown in a state without elastic displacement, but the contact arm portions 24 and 25 are actually elastically displaced downward.

In this manner, in the present embodiment, the flat conductor C is indirectly sandwiched by the pressing arm portion 26 and the contact arm portions 24 and 25, and contact pressure between the contact portions 24A and 25A and the circuit portions of the flat conductor C is increased. Accordingly, during use of the connector 1, even when the connector 1 receives external vibration and the intermediate portion 27 and the contact arm portions 24 and 25 elastically displace to follow the vibration, the sandwiched state of the flat conductor C is maintained. As a result, a state where the contact portions 24A and 25A and the circuit portions of the flat conductor C contact with high contact pressure can be satisfactorily maintained.

In addition, in the present embodiment, during a process in which the movable member 50 rotates toward the closed position, the slider 40 is brought forward of the advanced position, thereby causing the intermediate portion 27 of the terminal 20 to be elastically displaced (compressed) to the maximum. In contrast, when the movable member 50 reaches the closed position, the slider 40 has retracted to the advanced position, and the intermediate portion 27 is in a state where the elastic displacement amount has decreased. In other words, in a state where the flat conductor C is connected to the connector 1, the intermediate portion 27 has a softer spring characteristic and is more easily elastically displaceable as compared with a state where the intermediate portion 27 is elastically displaced to the maximum. Accordingly, when the connector 1 receives external vibration, the intermediate portion 27 can satisfactorily follow the vibration by elastic displacement of a sufficient elastic displacement amount. In addition, at this time, since the base arm portion 23 is separated from the held portion 21, the intermediate portion 27 can elastically displace smoothly.

Next, a withdrawal operation of the flat conductor C from the connector 1 will be described. When the flat conductor C inserted and connected to the connector 1 is withdrawn, a finger is hooked on the operation portion 51 of the movable member 50 at the closed position, and the movable member 50 is rotated in the opening direction with an operation force larger than an engagement force between the restricting portion 43A-2 and the restricted portion 54D, thereby moving the movable member 50 to the open position. When the engaged state between the restricting portion 43A-2 and the restricted portion 54D is released and the movable member 50 is further rotated in the opening direction, the slider 40 is pressed by the front pressing portion 54A at the projection 43A-1 to once move forward of the advanced position and then retracts due to an elastic reaction force (restoring force) of the intermediate portion 27 of the terminal 20 with further rotation of the movable member 50. In addition, pressing of the rear pressed portion 43B of the slider 40 by the rear pressing portion 54B of the cam portion 54 causes the slider 40 to retract toward the retracted position. When the movable member 50 reaches the open position, the slider 40 is brought to the retracted position.

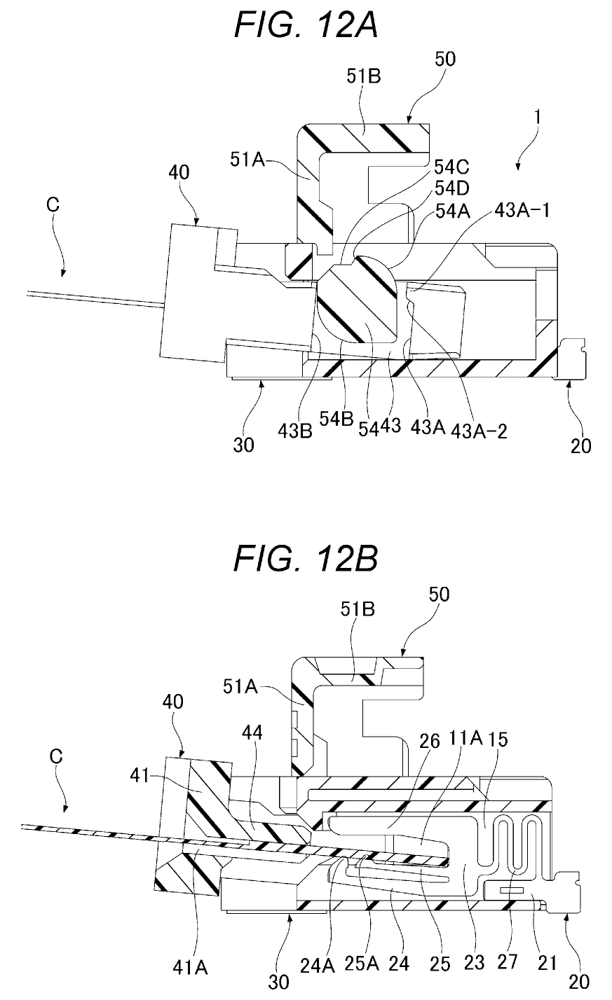

Next, in a state where the slider 40 is at the retracted position, as shown in FIGS. 12A and 12B, a rear end side of the flat conductor C is lifted upward. At this time, the pressing plate portion 44 of the slider 40 is in a state removed from between the pressing arm portion 26 and the contact arm portions 24 and 25. Therefore, the flat conductor C and the slider 40 can be easily lifted, and the flat conductor C and the slider 40 are in an inclined posture with a front end side lowered. As a result, an engaged state between the retained portion C2A of the flat conductor C and the retention projection 12A of the housing 10 is released. Then, pulling the flat conductor C obliquely upward and rearward enables easy withdrawal of the flat conductor C from the connector 1.

The connector 1 of the present disclosure can be configured as follows.

The movable member 50 has the cam portion 54 that rotates with rotation of the movable member 50. The cam portion 54 has a pressing portion (front pressing portion 54A) that presses the slider 40 (pressing plate portion 44) forward.

The terminal 20 has the held portion 21 held by the front wall of the housing 10, the base arm portion 23, the pressing arm portion 26 extending rearward from the base arm portion 23 and contacting the slider 40 (pressing plate portion 44), the contact arm portions 24 and 25 extending rearward from the base arm portion 23 and having the contact portions 24A and 25A contacting the flat conductor C, and the intermediate portion 27 connecting the held portion 21 and the base arm portion 23. The intermediate portion 27 is configured to be elastically displaceable in the front-rear direction.

Assume that a position of the slider 40 (retracted position) when the movable member 50 is at the open position is defined as a first position, a position of the slider 40 when the movable member 50 is between the open position and the closed position is defined as a second position, and a position of the slider 40 (advanced position) when the movable member 50 is at the closed position is defined as a third position. In this case, the second position is located forward of the first position, and the third position is located rearward of the second position and forward of the first position.

When the movable member 50 is between the open position and the closed position, or when the movable member 50 is within a predetermined rotation range between the open position and the closed position, the pressing portion (front pressing portion 54A) of the cam portion 54 presses the slider 40 forward. The pressed slider 40 urges the intermediate portion 27 of the terminal 20 forward. The intermediate portion 27 urged by the slider 40 elastically displaces in a compression direction in the front-rear direction. As a result, the slider 40 moves from the first position (retracted position) to the second position located forward of the first position (retracted position).

When the movable member 50 rotates to the closed position, forward pressing of the slider 40 by the pressing portion of the cam portion 54 is released, and urging of the intermediate portion 27 by the slider 40 is also released. As a result, the slider 40 (pressing plate portion 44) is pushed rearward by an elastic reaction force (restoring force) of the intermediate portion 27, and the slider 40 moves from the second position to the third position (advanced position).

When the movable member 50 is at the closed position, the intermediate portion 27 is in a free state (a state where elastic displacement has been eliminated) or is in a state elastically displaced slightly in the compression direction. That is, an elastic displacement amount of the intermediate portion 27 when the movable member 50 is at the closed position is smaller than an elastic displacement amount when the movable member 50 is between the open position and the closed position. Therefore, in a state where the movable member 50 is at the closed position and the slider 40 is at the third position (advanced position), namely, in a state where connection between the connector 1 and the flat conductor C has been completed, the intermediate portion 27 of the terminal 20 can secure a sufficient elastic displacement amount.

In the present embodiment, movement of the movable member 50 has been described as being achieved by rotation between the open position and the closed position, but the present disclosure is not limited to this configuration. As a modification, the movable member may be configured to slide in the front-rear direction during rotation between the open position and the closed position.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector for a flat conductor, comprising:
a plurality of terminals arranged in a left-right direction;
a housing that holds the plurality of terminals;
a slider; and
a movable member,
wherein the slider is attached to the housing from a rear side to be movable in a front-rear direction,
the movable member is attached to the housing to be rotatable between an open position having an orientation at a predetermined angle with respect to the front-rear direction and allowing withdrawal of a flat conductor and a closed position having an orientation along the front-rear direction and restricting withdrawal of the flat conductor,
the movable member has a cam portion that rotates with rotation of the movable member,
the cam portion has a pressing portion that presses the slider forward when the movable member is between the open position and the closed position,
the plurality of terminals each have a held portion held by a front wall of the housing, a base arm portion, a pressing arm portion extending rearward from the base arm portion and contacting the slider, a contact arm portion extending rearward from the base arm portion and having a contact portion contacting the flat conductor, and an intermediate portion connecting the held portion and the base arm portion and elastically displaceable in the front-rear direction,
when the movable member is at the open position, the slider is positioned at a first position,
when the movable member is between the open position and the closed position, the slider is pressed forward by the pressing portion, and the intermediate portion urged by the pressed slider elastically displaces in a compression direction, thereby moving the slider from the first position to a second position located forward of the first position, and
when the movable member is at the closed position, forward pressing of the slider by the pressing portion is released, and the slider is pushed rearward by an elastic reaction force of the intermediate portion, thereby moving the slider from the second position to a third position located rearward of the second position and forward of the first position.

2. The electrical connector for a flat conductor according to claim 1, wherein the cam portion has a notch portion formed at a position adjacent to the pressing portion, and a stepped restricted portion formed at a boundary position between the pressing portion and the notch portion, and
the slider has a stepped restricting portion engageable with the stepped restricted portion when the slider is at the third position.

3. The electrical connector for a flat conductor according to claim 1, wherein the intermediate portion has at least one portion curved in a plane orthogonal to the left-right direction.

4. The electrical connector for a flat conductor according to claim 1, wherein the movable member has an engaging portion engageable with the housing when the movable member is at the open position.
